(19) United States
(12) Patent Application Publication
(10) Pub. No.: US 2013/0173933 A1
(43) Pub. Date: Jul. 4, 2013

(54) PERFORMANCE OF A POWER CONSTRAINED PROCESSOR

(71) Applicants: Karthik Ramani, Sunnyvale, CA (US); John W. Brothers, Sunnyvale, CA (US); Stephen Presant, Sunnyvale, CA (US)

(72) Inventors: Karthik Ramani, Sunnyvale, CA (US); John W. Brothers, Sunnyvale, CA (US); Stephen Presant, Sunnyvale, CA (US)

(73) Assignee: Advanced Micro Devices, Inc., Sunnyvale, CA (US)

(21) Appl. No.: 13/340,032

(22) Filed: Dec. 29, 2011

(51) Int. Cl. G06F 1/26

(52) U.S. Cl. 713/300

(57) ABSTRACT

Provided is a method for improving performance of a processor. The method includes computing utilization values of components within the processor and determining a maximum utilization value based upon the computed utilization values. The method also includes comparing (i) the maximum utilization value with a first threshold and (ii) differences between the computed utilization values and a second threshold.

### BACKGROUND

1. Field of the Invention

The present invention is generally directed to computing systems. More particularly, the present invention is directed to improving performance of a power constrained accelerated processing device (APD).

2. Background Art

Conventional computer systems often include a number of APDs, each including a number of interrelated modules or sub-components to perform critical image processing functions. Examples of these sub-components include single instruction multiple data execution units (SIMDs), blending functions (BFs), memory controller, external memory interfaces, internal memory (cache or data buffers), programmable processing arrays, command processors (CP) and dispatch controllers (DCs).

APD sub-components generally function independently, but often depend on other sub-components for their inputs, and also provide outputs to other sub-components. The workloads of the sub-components vary for different applications or tasks. However, the conventional computer systems typically operate all the sub-components, within the APD, at the same power and frequency level. This approach limits the overall performance of the APD since it fails to determine specific power and frequency level settings that would optimize the performance of individual sub-components.

As understood by those of skill in the relevant art, module work load requirements, environmental conditions, and other factors, affect the power and frequency level settings of the individual sub-components within the APD. Although, the total power of all the sub-components is constrained, the inability of the conventional approach, described above, to optimize the performance of individual modules reduces the APD's overall performance to suboptimal levels.

### SUMMARY OF EMBODIMENTS OF THE INVENTION

What is needed therefore, are methods and systems to improve performance of processors, such as APD's, by optimizing power and frequency level settings of individual APD sub-components.

Although graphics processing units (GPUs), accelerated processing units (APUs), and general purpose use of the graphics processing unit (GPGPU) are commonly used terms in this field, the expression APD is considered to be a broader expression. For example, APD refers to any cooperating collection of hardware and/or software that performs those functions and computations associated with accelerating graphics processing tasks, data parallel tasks, or nested data parallel tasks in an accelerated manner with respect to resources such as conventional CPUs, conventional GPUs, and/or combinations thereof.

Embodiments of the disclosed invention, under certain circumstances, provide a method for improving performance of a processor. The method includes computing utilization values of components within the processor and determining a maximum utilization value based upon the computed utilization values. The method also includes comparing (i) the maximum utilization value with a first threshold and (ii) differences between the computed utilization values and a second threshold.

The embodiments of the present invention can be used in any computing system (e.g., conventional computer (desktop, notebook, etc.), computing device, entertainment system, media system, game system, communication device, tablet, mobile device, personal digital assistant, etc.), or any other system using one or more processors.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1A is an illustrative block diagram of a processing system in accordance with embodiments of the present invention.

FIG. 1B is an illustrative block diagram illustration of an APD illustrated in FIG. 1A, according to an embodiment.

FIG. 2 is a more detailed block diagram of the APD illustrated in FIG. 1B.

FIG. 3A is a block diagram of a conventional APD with a single voltage domain.

FIG. 3B is an illustrative block diagram of an APD with multiple voltage domains in accordance with an embodiment of the present invention

FIG. 4 is an illustrative flow chart of an APD using multiple voltage domains to improve performance of a GPU.

FIG. 5 is a flow chart of an exemplary method practicing an embodiment of the present invention.

### DETAILED DESCRIPTION OF THE EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

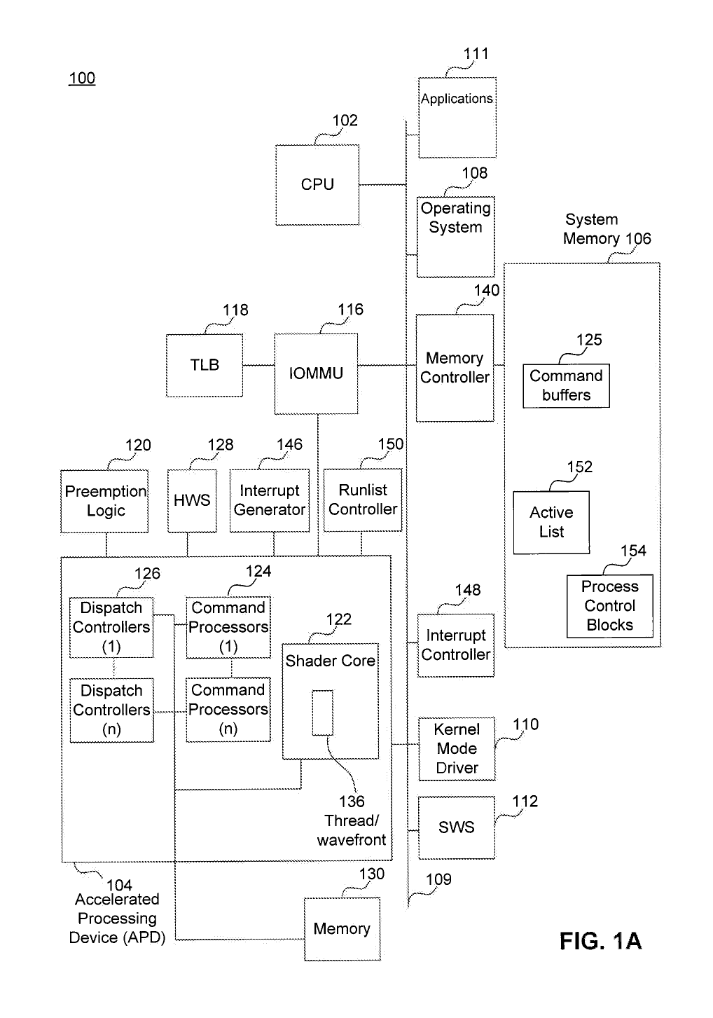

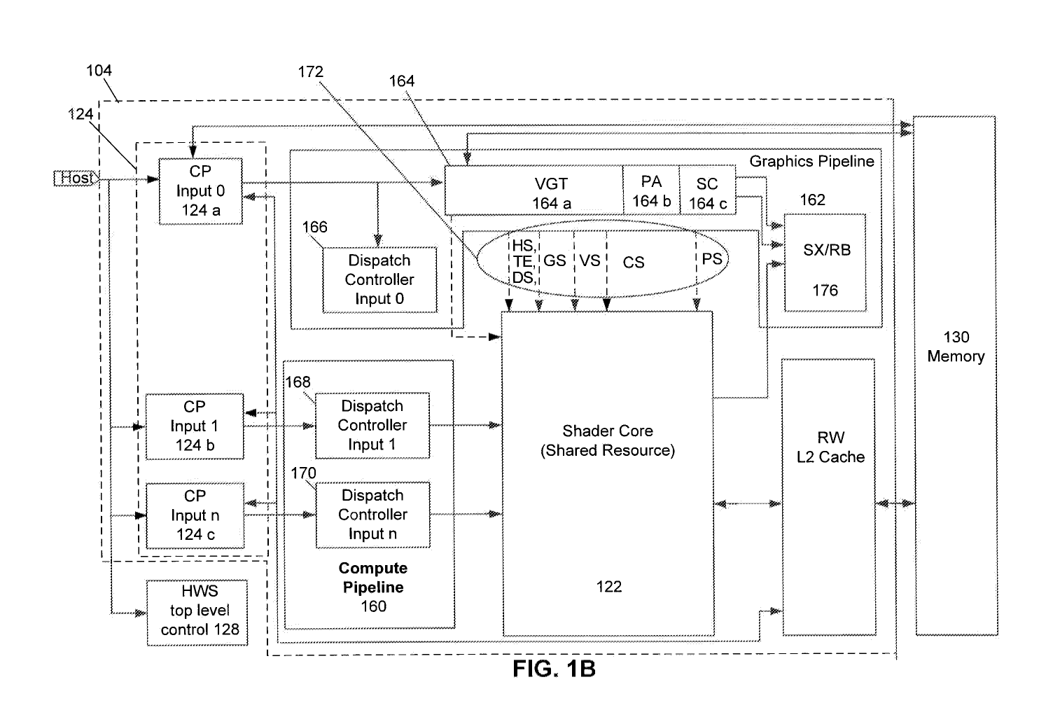

FIG. 1A is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an operating system 108, and a communication infrastructure 109. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1A.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. In one example, drivers are hardware-dependent and operating-system-specific. They usually provide the interrupt handling required for any necessary asynchronous time-dependent hardware interface.

CPU 102 can include (not shown) one or more of a control processor; field programmable gate array (FPGA), application specific integrated circuit (ASIC), or digital signal processor (DSP). CPU 102, for example, executes the control logic, including the operating system 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the instruction set architecture (ISA). A command may be executed by a special processor such a dispatch processor, command processor, or network controller. On the other hand, instructions can be considered, for example, a single operation of a processor within a computer's architecture. In one example, when using two sets of ISAs, some instructions are used to execute x86 programs and some instructions are used to execute kernels on an APD compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as those that are common in graphics processing.

A work-item is distinguished from other executions within the collection by its global ID and local ID. In one example, a subset of work-items in a workgroup that execute simultaneously together on a SIMD can be referred to as a wavefront 136. The width of a wavefront is a characteristic of the hardware of the compute unit (e.g., SIMD processing core). As referred to herein, a workgroup is a collection of related work-items that execute on a single compute unit. The work-items in the group execute the same kernel and share local memory and work-group barriers.

Within the system 100, APD 104 includes its own memory, such as graphics memory 130 (although memory 130 is not limited to graphics only use). Graphics memory 130 provides a local memory for use during computations in APD 104. Individual compute units (not shown) within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of CPs 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and APD.

A plurality of command buffers 125 can be maintained with each process scheduled for execution on the APD 104.

CP 124 can be implemented in hardware, firmware, or software, or a combination thereof. In one embodiment, CP 124 is implemented as a reduced instruction set computer (RISC) engine with microcode for implementing logic including scheduling logic.

APD 104 also includes one or “n” number of DCs 126. In the present application, the term dispatch refers to a command executed by a dispatch controller that uses the context state to initiate the start of the execution of a kernel for a set of work groups on a set of compute units. DC 126 includes logic to initiate workgroups in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

APD 104 can have access to, or may include, an interrupt generator 146. Interrupt generator 146 can be configured by APD 104 to interrupt the operating system 108 when interrupt events, such as page faults, are encountered by APD 104. For example, APD 104 can rely on interrupt generation logic within IOMMU 116 to create the page fault interrupts noted above.

APD 104 can also include preemption and context switch logic 120 for preempting a process currently running within shader core 122. Context switch logic 120, for example, includes functionality to stop the process and save its current state (e.g., shader core 122 state, and CP 124 state).

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Processing logic for applications, operating system, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160. Also provided is a controller mechanism 166 for controlling operation of HWS 128.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Other implementations can be used that would also be within the spirit and scope of the present invention.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a. Compute work submitted through DC 166 is semi-synchronous with graphics pipeline 162.

Compute pipeline 160 includes shader DCs 168 and 170. Each of the DCs 168 and 170 is configured to count through compute ranges within work groups received from CP pipelines 124b and 124c.

The DCs 166, 168, and 170, illustrated in FIG. 1B, receive the input ranges, break the ranges down into workgroups, and then forward the workgroups to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes. An exception is for graphics work in shader core 122, which can be context switched.

After the processing of work within graphics pipeline 162 has been completed, the completed work is processed through a render back unit 176, which does depth and color calculations, and then writes its final results to memory 130.

Shader core 122 can be shared by graphics pipeline 162 and compute pipeline 160. Shader core 122 can be a general processor configured to run wavefronts. In one example, all work within compute pipeline 160 is processed within shader core 122. Shader core 122 runs programmable software code and includes various forms of data, such as state data.

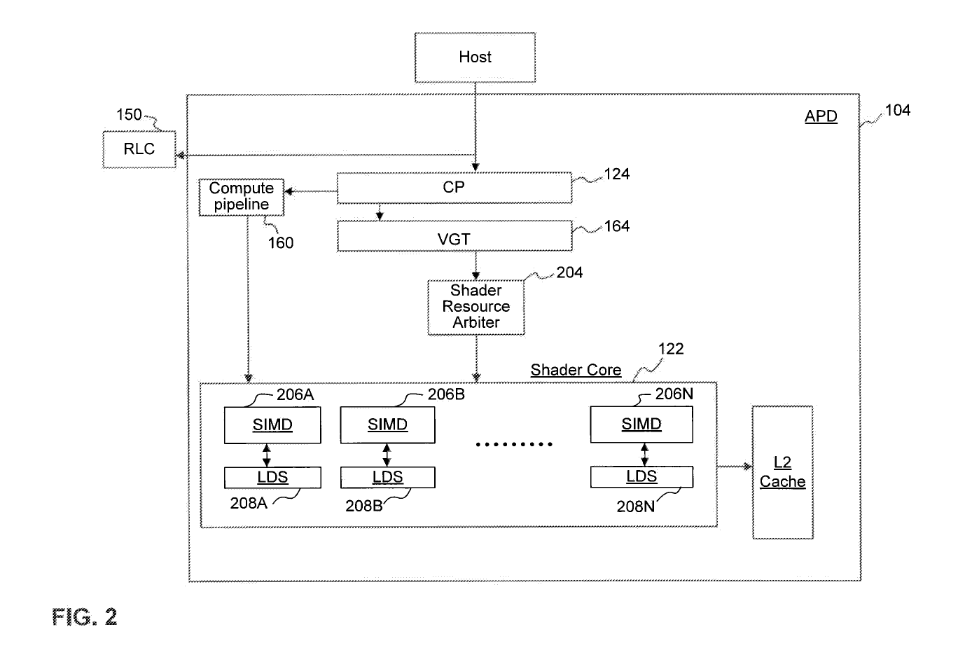

FIG. 2 is a block diagram showing greater detail of APD 104 illustrated in FIG. 1B. In the illustration of FIG. 2, APD 104 includes a shader resource arbiter 204 to arbitrate access to shader core 122. In FIG. 2, shader resource arbiter 204 is external to shader core 122. In another embodiment, shader resource arbiter 204 can be within shader core 122. In a further embodiment, shader resource arbiter 204 can be included in graphics pipeline 162. Shader resource arbiter 204 can be configured to communicate with compute pipeline 160, graphics pipeline 162, or shader core 122.

Shader resource arbiter 204 can be implemented using hardware, software, firmware, or any combination thereof. For example, shader resource arbiter 204 can be implemented as programmable hardware.

As discussed above, compute pipeline 160 includes DCs 168 and 170, as illustrated in FIG. 1B, which receive the input thread groups. The thread groups are broken down into wavefronts including a predetermined number of threads. Each wavefront thread may comprise a shader program, such as a vertex shader. The shader program is typically associated with a set of context state data. The shader program is forwarded to shader core 122 for shader core program execution.

During operation, each shader core program has access to a number of general purpose registers (GPRs) (not shown), which are dynamically allocated in shader core 122 before running the program. When a wavefront is ready to be processed, shader resource arbiter 204 allocates the GFRs and thread space. Shader core 122 is notified that a new wavefront is ready for execution and runs the shader core program on the wavefront.

As referenced in FIG. 1A, APD 104 includes compute units, such as one or more SIMDs. In FIG. 2, for example, shader core 122 includes SIMDs 206A-206N for executing a respective instantiation of a particular work group or to process incoming data. SIMDs 206A-206N are respectively coupled to local data stores (LDSs) 208A-208N. LDSs 208A-208N provide a private memory region accessible only by their respective SIMDs and is private to a work group. LDSs 208A-208N store the shader program context state data.

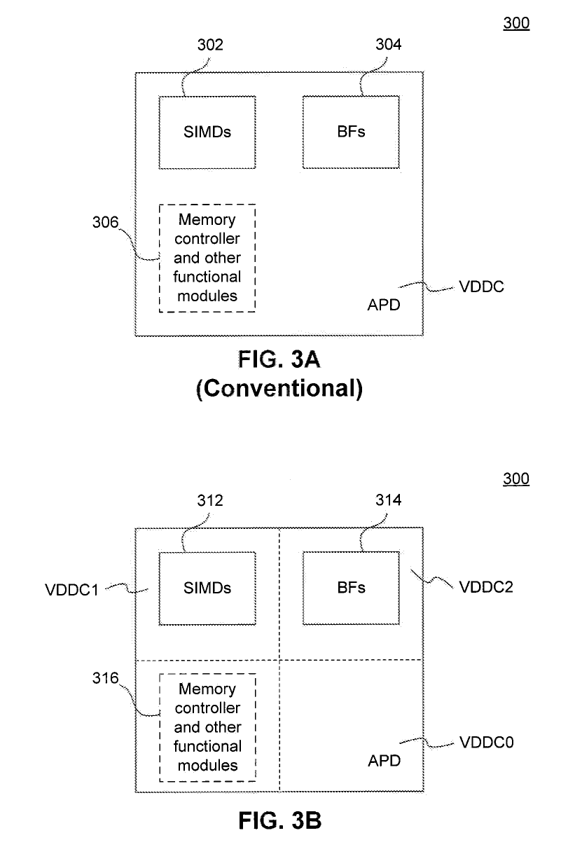

FIG. 3A is an illustrative block diagram of a conventional APD 300 with a single voltage domain. In FIG. 3A, a single supply voltage (VDDC) is provided to APD 300 including sub-components SIMDs 302, BFs 304, and other modules 306. As a result, the internal sub-components SIMDs 302, BFs 304, and modules 306 operate off the same supply voltage VDDC.

The conventional APD 300 is unable to recognize that one or more of the sub-components SIMDs 302 and BFs 304 might perform better using a voltage level different than VDDC. The supply of a sub optimal voltage level to individual sub-components SIMDs 302 and BFs 304 renders the APD 300 unable to achieve optimal performance levels.

FIG. 3B is an illustrative block diagram of an APD 310 constructed in accordance with an embodiment of the present invention. In FIG. 3B, APD 310 includes multiple voltage domains, each being associated with one of the sub-component SIMDs 312 and BFs 314. In embodiments of the present invention, domains are created by

For example, one simple way to categorize the sub-components SIMDs 312 and BFs 314 can be categorized based upon their association with various pipeline stages within the APD 310. That is, although in the exemplary embodiment of FIG. 3B, voltage domains are associated with SIMDs and BFs, other embodiments of the present invention can associate voltage domains with various pipeline stages within the APD 310. Additionally, other domains can be created based upon other performance criteria, such as frequency.

In the illustrious embodiment of FIG. 3B, the sub-component SIMDs 312 and BFs 314 correspond to individual voltage domains VDDC1 and VDDC 2, respectively. More specifically, in FIG. 3B individual supply voltages are used to power SIMDs 312 and BFs 314. VDDC0 provides power to APD 310, including to memory controller module 316. The present invention, however, is not limited to the three voltage domains described above. These three voltage domains are shown by way of an example only, and not as a limitation.

At a high level, as explained in greater detail below, embodiments of the present invention enable a user to identify critical and noncritical APD internal sub-components. A critical sub-component, for example, can include a sub-component whose performance can be dynamically increased to optimize the overall performance of the APD. In the embodiments, for example, the user computes an initial utilization of all of the sub-components. The initial utilization data can be analyzed to determine whether increasing selected characteristics will enhance the processor throughput. If the throughput can be enhanced by increasing, for example, the sub-components operating frequency, the sub-component will be classified as critical. Each critical sub-component, or groups of critical sub-component, will be considered a domain.

Throughput capabilities associated with each domain (e.g., voltage domains), can be controlled using numerous control variables within the APD, available to the user. Further, each of the individual voltage domains can be managed independently and optimization levels can be achieved for a particular domain or group of domains. Management of the multiple voltage domains can occur, for example, in a manner consistent with the overall power budget of APD 310.

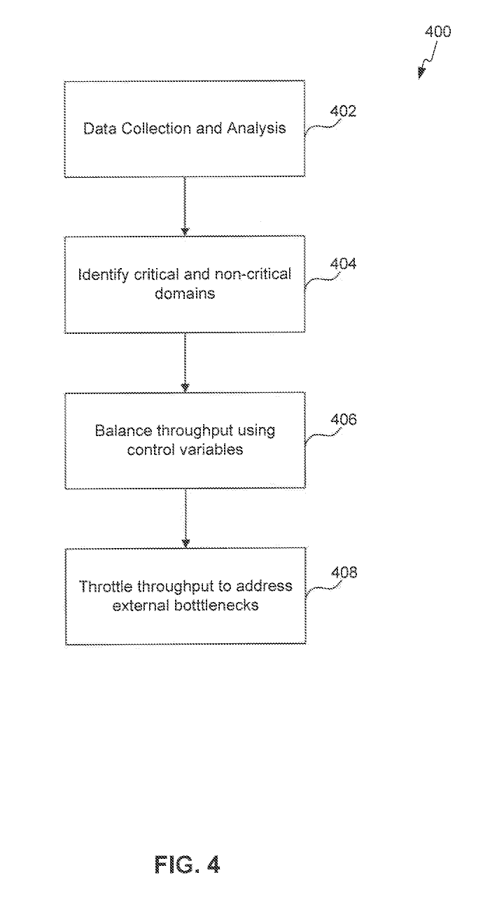

FIG. 4 is a flow chart of an exemplary high live method 400 of practicing embodiment of the present invention.

In operation 402, of the method 400, throughput requirements of an application running in a processor, such as APD 310 of FIG. 3B. In the method 400, an analysis is performed on data related to APD 310 and collected over a period of time by APD internal counters (not shown). The results of this analysis are used to identify sub-components of the APD that are either limiting overall performance of the APD or sub-components and achieve higher performance levels than required. The collection and analysis of data can be performed proactively or reactively.

At operation 404, and as noted above, sub-components achieving higher performance, but running at lower than peak rate, are identified and are referred to herein as critical domains. Identification of the critical groups of sub-components helps achieve optimal performance of APD 310.

The groups of sub-components that are currently delivering higher performance than required, and whose performance can be lowered without affecting the overall performance of an APD, are referred to herein as non-critical. In operation 404, all groups with matching characteristics, critical or non-critical, as defined above, are identified.

At operation 406, the throughputs of the groups of sub-components identified in operation 404 are balanced in such a way that results in increased overall performance of APD 310 and/or results in improved power efficiency of the APD. This operation is referred to as the balancing act.

The voltage and frequency of critical domains can be adjusted (e.g., increased) to attain a higher level of performance. At the same time, the voltage and frequency of non-critical domains can be adjusted (e.g., decreased) to attain improved power efficiency. However, this is desirably implemented in such a way that the overall performance of the APD 310 is not affected, and the APD is still within its overall power budget.

In the example of FIG. 3B, domain VDDC1 could be running at 75% of its peak rate, thus limiting the overall performance of APD 310. Domains VDDC2 and VDDC0, however, could be running at 50% and 30% of their peak rate, respectively. In the example of FIG. 3B, however, domains VDDC2 and VDDC0 could both run slower without limiting the overall performance of APD 310, and improve power efficiency.

Since domains VDDC0, VDDC1, and VDDC2 are independently controlled voltage domains, the voltage and frequency to each of the these domains can be independently increased or decreased without affecting the other domains. In the above example, the voltage and frequency to VDDC 1 could be increased so that it runs at 100% of its peak rate, thus attaining higher performance.

The voltage and frequency to domains VDDC2 and VDDC0 could be reduced to 25% of their peak rate which may result in power savings. The resulting power savings can result in increased battery life. In the embodiments, the underlying goal of any balancing action directed to an individual domain would be to increase the overall performance of the APD. Substantial power savings could also be achieved as a result of the balancing action.

In an idle state, individual enabled modules still consume a minimal, but measurable, amount of power. Thus, keeping all components enabled, at any power level, even if unused or underutilized, wastes power. If some voltage domains are not needed (for example, when refreshing display), they can be disabled to reduce power leakage.

As voltages vary independently to each domain, traditional clock trees would have significant skew. Thus, the crossings should be managed in a manner that avoids clock trees crossing voltage boundaries. It is apparent to a person skilled in the relevant art how to control the crossing implications.

By way of example, at operation 408, additional throttling can to be performed in APD 310 if the overall performance of the APD is limited due to a component external to the APD. It may be, for example, due to a throughput bottleneck caused by CPU 102 or system memory 106 of APD 104. In such a scenario, the throughput of all domains, including critical and non-critical domains, can be reduced proportionately to achieve additional power savings. The throttling is performed to drop the voltage and frequency to balance to the external factor limiting the performance of the APD.

The additional throttling described above is not required for the current invention to work, but rather an additional way to improve power efficiency without affecting the overall performance of the APD.

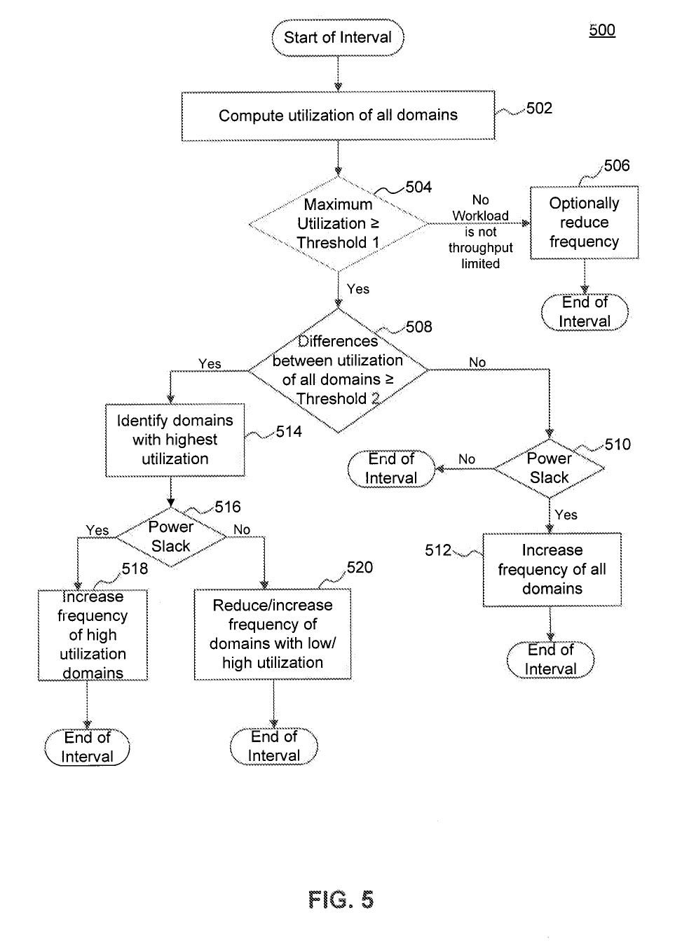

FIG. 5 is a flow chart of an exemplary method 500 practicing an embodiment of the present invention. FIG. 5 is an illustration of details of operations 404-408 described above, according to an embodiment of the present invention. For example, operations 502-520 can be performed to implement at least some of the functionality of operations 404-408 described above. Operations 404-408 need not occur in the order shown in method 500, or require all of the steps illustrated.

In operation 502, utilization values of all sub-components or domains of APD 310 are computed. The utilization values may be computed using information collected by the various internal counters of APD 310.

In operation 504, maximum utilization value from all the utilization values computed in operation 502 above is determined. It is then determined whether the maximum utilization value identified is greater (or equal to) than a first threshold value (“threshold 1”). The first threshold value can be preconfigured or dynamically programmed based on workload.

If the maximum utilization value determined above is not greater than or equal to threshold 1, the workload of the sub-components are not deemed to be throughput limited. However, the frequency to these components could optionally be reduced for power savings in operation 506. As a result, the power efficiency of APD 310 is improved.

If the maximum utilization value determined above is greater than or equal to threshold 1, the workload of the sub-components are deemed to be throughput limited.

In operation 508, differences between the utilization values of the sub-components computed in operation 502 above, are calculated. A determination is made as to whether the differences between utilization values of the sub-components are greater than or equal to a second threshold value (“threshold 2”). The second threshold value can be preconfigured or dynamically programmed based on workload.

If the differences between utilization values of the sub-components are not greater than or equal to threshold 2, it is determined in operation 510 whether there is available power slack. Power slack, as used herein, refers to the difference between thermal design power (TDP) and current power usage of APD 310. f power slack is available, the frequency of all sub-components is increased proportionally based on power slack. Fₘₐₓ (maximum frequency of design) for all sub-components is enforced, and the interval ends at operation 512.

If the differences between utilization values of the sub-components are greater than or equal to threshold 2, the sub-components having the highest utilization values are determined in operation 514.

In operation 516, it is determined whether power slack is available. If there is power slack, the frequency of high utilization sub-components is increased based on the amount of power slack. Fmax (maximum frequency of design) for all sub-components is enforced, and the interval ends at operation 518.

If there is no power slack, frequency of domains with low utilization values is reduced, and the frequency of domains with high utilization value is increased proportionally based on utilization differences (operation 520). Fmax (maximum frequency of design) for all sub-components is enforced, and the interval ends. The method 500 is repeated for the next interval.

Embodiments of the present invention seek to allocate more power to the sub-components that are the performance bottlenecks, and less power to the components that have performance slack. The allocation depends on the task. The embodiments use, for example, multiple voltage rails that are independently controlled. For optimal performance, each sub-component can have its own voltage rail. Separate voltage rails, however, are not required.

The techniques discussed above eliminate the need for sub-components of an API) to operate at a single power and frequency which may not only limit the overall performance of the APD but may result in power inefficiency as well. These techniques provide methods and systems for evaluating the relative performance for different system on chip (SoC) candidate configurations for which sub-components are allocated to different voltage domains or rails.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It should be noted that the simulation, synthesis and/or manufacture of the various embodiments of this invention can be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools) and/or any other type of CAD tools.

This computer readable code can be disposed in any known computer usable medium including semiconductor, magnetic disk, optical disk (such as CD-ROM, DVD-ROM) and as a computer data signal embodied in a computer usable (e.g., readable) transmission medium. As such, the code can be transmitted over communication networks including the Internet and intranets. It is understood that the functions accomplished and/or structure provided by the systems and techniques described above can be represented in a core (such as a GPU core) that is embodied in program code and can be transformed to hardware as part of the production of integrated circuits.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What we claim is:

1. A method for improving performance of a processor, comprising:
computing utilization values of components within the processor;
determining a maximum utilization value based upon the computed utilization values; and
comparing (i) the maximum utilization value with a first threshold and (ii) differences between the computed utilization values and a second threshold.

2. The method of claim 1, further comprising modifying utilization values of the components using control variables.

3. The method of claim 2, wherein the control variable is frequency.

4. The method of claim 2, wherein each component includes an independently controlled voltage rail.

5. The method of claim 2, further comprising throttling throughput to address throughput limitations caused by components outside of the processor.

6. The method of claim 5, where in the throughput limitation is caused by a central processing unit (CPU) or memory.

7. The method of claim 1, further comprising increasing frequency of high utilization components based on available power slack.

8. A system, comprising:
a memory device; and
a processing unit coupled to the memory device and configured to:
compute utilization values of components within the processing unit;
determine a maximum utilization value based upon the computed utilization values; and
compare (i) the maximum utilization value with a first threshold (ii) differences between the computed utilization values with a second threshold.

9. The system of claim 8, further comprising modifying utilization values of the components using control variables.

10. The system of claim 8, wherein each component has independently controlled voltage rail.

11. The system of claim 8, wherein frequency of a component is increased to improve performance of the processor.

12. A non-transitory computer readable medium having instructions recorded thereon that, when executed by a computing device, cause the computing device to perform a method to manage performance of a processor including a plurality of components, comprising:
computing utilization values of components in the processor;
determining a maximum utilization value based upon the computed utilization values; and
comparing (i) the maximum utilization value with a first threshold and (ii) differences between the computed utilization values and a second threshold.

13. The computer readable media of claim 12, further comprising:
modifying utilization values of the components using control variables.

14. The computer readable media of claim 13, wherein each component has independently controlled voltage rail.
